(19) United States
(12) Patent Application Publication
(10) Pub. No.: US 2014/0374934 A1
(43) Pub. Date: Dec. 25, 2014

(54) METHOD FOR STRENGTHENING SEMICONDUCTOR MANUFACTURING TOOLS

(71) Applicants: Greencore Technology Co. Ltd., Guishan Township (TW); Nanocrystal (Asia) Inc., Taipei (TW)

(72) Inventors: Chong Ming LEE, Taipei (TW); Chung-Hua Lee, Guishan Township (TW)

(73) Assignees: Greencore Technology Co. Ltd., Guishan Township (TW); Nanocrystal (Asia) Inc., Taipei (TW)

(21) Appl. No.: 13/948,958

(22) Filed: Jul. 23, 2013

(30) Foreign Application Priority Data
Jun. 19, 2013 (TW) 102121818

(51) Int. Cl. B29C 33/58

(52) U.S. Cl. CPC B29C 33/58
USPC 264/39

(57) ABSTRACT

A method for strengthening semiconductor manufacturing tools is provided. The method includes providing a mold insert, forming a native oxide layer, attaching a release agent film, and forming a glass bonded SiOₓ release agent layer. With the method, a firm glass bonded SiOₓ release agent layer is formed uniformly on the surface of the mold insert to make the mold insert of semiconductor manufacturing tools much more resistant to abrasion and durable, extend the service life of the mold insert, cut production costs of semiconductor manufacturing, enable easy release of the mold insert, and speed up semiconductor manufacturing. Furthermore, the uniformity of the glass bonded SiOₓ release agent layer on the surface of the mold insert helps promote the yield when making sub-molds by the mold insert.

### BACKGROUND OF THE INVENTION

1. Technical Field

The present invention relates to methods for strengthening semiconductor manufacturing tools, and more particularly, to a method for strengthening semiconductor manufacturing tools and thereby forming a glass bonded SiOₓ release agent layer.

2. Description of Related Art

As regards semiconductor manufacturing tools, mold inserts for use in impression are made mostly of silicon or silicates and adapted to re-impress a plurality of sub-molds. In general, mold inserts must be plated with a release agent film. The release agent film is made mostly of silane derivatives.

Referring to FIG. 1, a conventional plating process of a release agent film entails forming a film of release agent gas 31 on a mold insert 10 by evaporation using a release agent film 30. However, wear or defects severe enough to be discerned by the naked eye occur to the film of release agent gas 31 formed by a conventional evaporation process. The wear or defects render it difficult to release the mold insert 10, reduce the durability of the mold insert 10 greatly, and deteriorate the yield of sub-molds manufactured by means of the mold insert 10, thereby ending up in a predicament—ever-increasing semiconductor manufacturing process costs accompanied by failure to speed up semiconductor manufacturing.

Accordingly, it is imperative to provide a method for strengthening semiconductor manufacturing tools and thereby forming on the surface of a mold insert a film which is firm, durable, and insusceptible to wear or defects with a view to cutting semiconductor manufacturing process costs and speeding up semiconductor manufacturing.

### SUMMARY OF THE INVENTION

The present invention provides a method for strengthening semiconductor manufacturing tools and thereby forming a firm glass bonded SiOₓ release agent layer which uniformly covers the surface of a mold insert. The mold insert of the semiconductor manufacturing tools reduces wear, enhances the durability of the mold insert, cuts costs, renders it easy to release the mold insert, and speeds up semiconductor manufacturing. The uniform distribution of the glass bonded SiOₓ release agent layer on the surface of the mold insert is conducive to enhancement of the yield when making sub-molds by the mold insert.

The present invention provides a method for strengthening semiconductor manufacturing tools, comprising the steps of: providing a mold insert; forming a native oxide layer, wherein the native oxide layer is formed by performing heat treatment on the mold insert at a high temperature and is formed on a surface of the mold insert; attaching a release agent film, wherein a release agent is heated to reach a boiling point for producing a release agent gas and the release agent gas adheres to the native oxide layer; and forming a glass bonded SiOₓ release agent layer, wherein an oxygen is introduced and the mold insert is irradiated with an ultraviolet, and a strengthening condensation reaction is performed on the native oxide layer to thereby form a uniform glass bonded SiOₓ release agent layer.

Implementation of the present invention at least involves the following inventive steps:

1.reducing abrasion, enhancing durability of a mold insert, and cutting costs;

2. enabling easy release of the mold insert, and speeding up semiconductor manufacturing; and

3. increasing the yield when making sub-molds by the mold insert, and cutting costs.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 (PRIOR ART) is a schematic view of a conventional evaporation method for forming a film of release agent gas on a mold insert;

FIG. 2 is a flow chart of a method for strengthening semiconductor manufacturing tools according to the embodiment of the present invention;

FIG. 3 is a cross-sectional view of a mold insert according to the embodiment of the present invention;

FIG. 4 is a cross-sectional view of a native oxide layer formed on the mold insert according to the embodiment of the present invention;

FIG. 5 is a cross-sectional view of evaporating a release agent gas on a native oxide layer according to the embodiment of the present invention;

FIG. 6 is a cross-sectional view of introducing oxygen and irradiating with ultraviolet according to the embodiment of the present invention; and

FIG. 7 is a cross-sectional view of a glass bonded SiOₓ release agent layer formed according to the embodiment of the present invention.

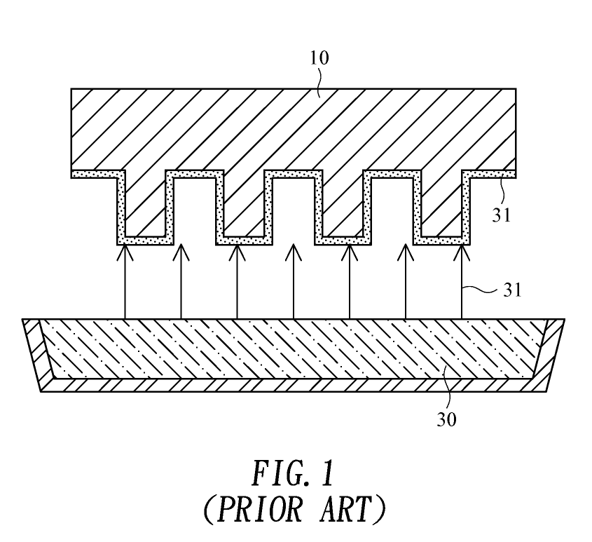

### DETAILED DESCRIPTION OF THE EMBODIMENTS OF THE INVENTION

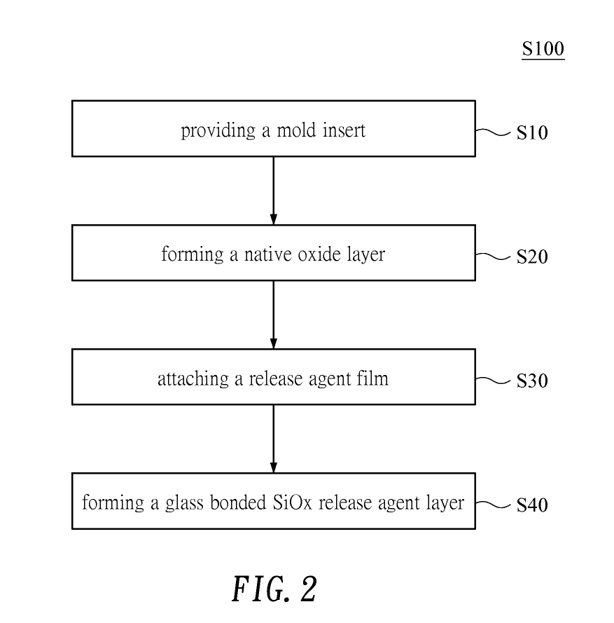

Referring to FIG. 2, in this embodiment, a method S100 for strengthening semiconductor manufacturing tools comprises the steps of: providing a mold insert (step S10); forming a native oxide layer (step S20); attaching a release agent film (step S30); and forming a glass bonded SiOₓ release agent layer (step S40).

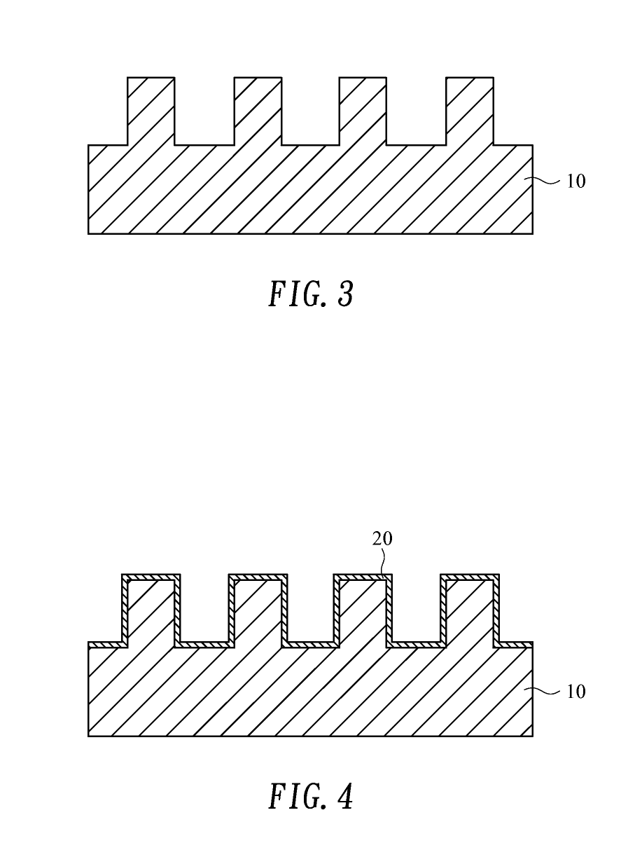

Referring to FIG. 2 and FIG. 3, in the step of providing a mold insert (step S10), a mold insert 10 is made of a material, such as monocrystalline silicon (s-Si), polycrystalline silicon (c-Si), silicon oxide (SiOₓ), silicon carbide (SiC), aluminum oxide (Al₂O₃), magnesium aluminum spinel (MgAl₂O₄), or zinc oxide (ZnO) or made of a mixture of at least two of the aforesaid materials.

Referring to FIG. 2 and FIG. 4, the step of forming a native oxide layer (step S20) entails performing heat treatment on the mold insert 10 at a high temperature to form a native oxide layer 20 on the surface of the mold insert 10, wherein the high temperature at which the step of forming a native oxide layer (step S20) is performed ranges from 200° C. to 600° C. The frequency of collision of molecules of oxygen 40 with the surface of the mold insert 10 increases with temperature. At a high temperature, molecules of oxygen 40 form readily a firm bond with the silicon molecules on the surface of the mold insert 10 to thereby form silicon dioxide (SiO₂) and form the continuous native oxide layer 20.

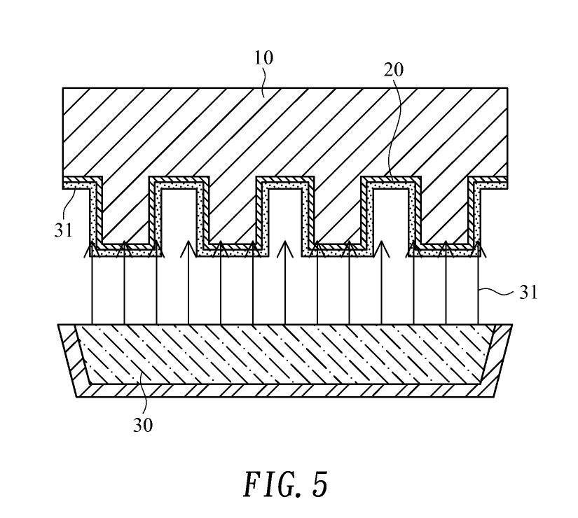

Referring to FIG. 2 and FIG. 5, the step of attaching a release agent film (step S30) entails heating a release agent film 30 to reach a boiling point for producing a release agent gas 31 and adhering the release agent gas 31 to the native oxide layer 20. The release agent film 30 is made of octadecyltrichlorosilane (OTS), a derivative thereof, another silane, or another silane derivative.

In the step of attaching a release agent film (step S30), silicon dioxide (SiO₂) of the native oxide layer 20 reacts with the release agent gas 31 to form Si—Cl bond and Si—OH bond.

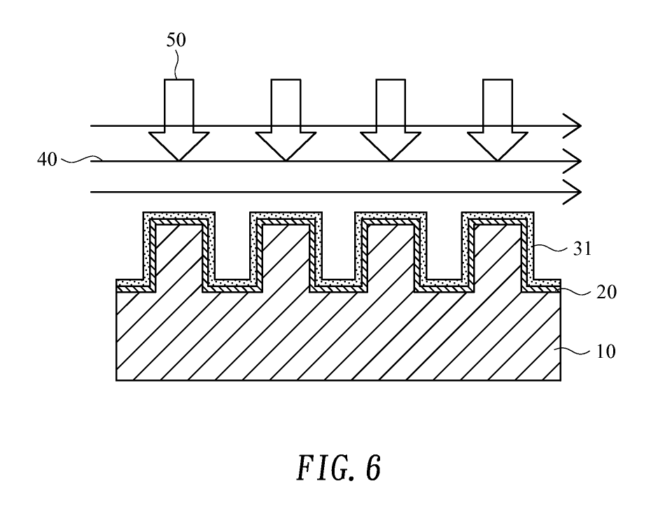

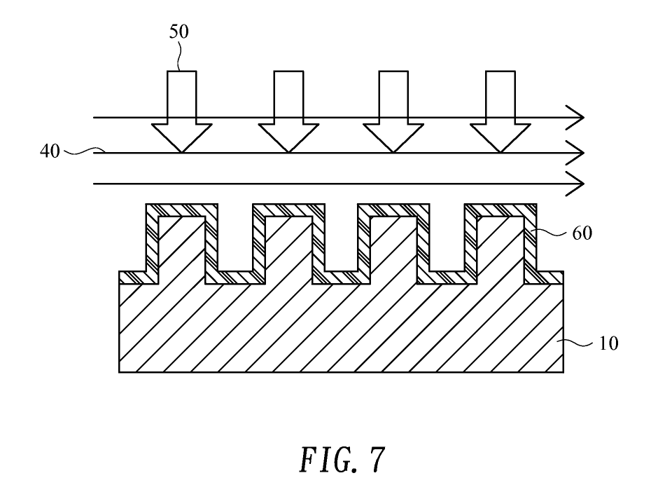

Referring to FIG. 2, FIG. 6 and FIG. 7, the step of forming a glass bonded SiOₓ release agent layer (step S40) entails introducing an oxygen 40, irradiating the mold insert 10 with an ultraviolet 50(UV), and performing a strengthening condensation reaction on the native oxide layer 20 after the step of attaching a release agent film (step S30). The ultraviolet 50 for use in forming a glass bonded SiOₓ release agent layer (step S40) is of a wavelength from 10 nm to 400 nm.

In the presence of oxygen 40, the ultraviolet 50 irradiation not only causes oxygen 40 to react and turn into ozone ion (O₃) of higher activity, but the energy of the ultraviolet 50 is also sufficient to break the Si—Cl bond and Si—OH bond which are previously formed on the native oxide layer 20 in the step of attaching a release agent film 30 (step S30) and cause the ozone ion to react with the native oxide layer 20 to thereby form a firm uniform glass bonded SiOₓ release agent layer 60. The glass bonded SiOₓ release agent layer 60 is more uniform, firmer, and more durable than the conventional release agent layer produced by evaporation and thus can reduce the abrasion of the mold insert 10, enhance the durability of the mold insert 10, enable easy release of the mold insert 10, speed up semiconductor manufacturing, increase the yield when making sub-molds by the mold insert 10, and cut costs.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A method for strengthening semiconductor manufacturing tools, the method comprising the steps of:
providing a mold insert;
forming a native oxide layer, wherein the native oxide layer is formed by performing heat treatment on the mold insert at a high temperature and is formed on a surface of the mold insert;
attaching a release agent film, wherein a release agent is heated to reach a boiling point for producing a release agent gas and the release agent gas adheres to the native oxide layer; and
forming a glass bonded SiOₓ release agent layer, wherein an oxygen is introduced and the mold insert is irradiated with an ultraviolet, and a strengthening condensation reaction is performed on the native oxide layer to thereby form a uniform glass bonded SiOₓ release agent layer.

2. The method of claim 1, wherein the mold insert is made of a material, including monocrystalline silicon, polycrystalline silicon, silicon oxide, silicon carbide, aluminum oxide, magnesium aluminum spinel, or zinc oxide or made of a mixture of at least two of the aforesaid materials.

3. The method of claim 1, wherein the high temperature at which the step of forming a native oxide layer is performed ranges from 200° C. to 600° C.

4. The method of claim 1, wherein the ultraviolet is of a wavelength from 10 nm to 400 nm.

5. The method of claim 1, wherein the release agent film is made of one of octadecyltrichlorosilane (OTS), a derivative thereof, another silane, and another silane derivative.

6. The method of claim 1, wherein the glass bonded SiOₓ release agent layer is formed from silicon oxide (SiOₓ).
